(19) United States
(12) Patent Application Publication
(10) Pub. No.: US 2010/0002302 A1
(43) Pub. Date: Jan. 7, 2010

(54) METHOD AND APPARATUS FOR CHIEF RAY ANGLE CORRECTION USING A DIFFRACTIVE LENS

(76) Inventors: Jacques Duparre, Jana (DE); Jeff Viens, Boise, ID (US)

Correspondence Address: DICKSTEIN SHAPIRO LLP, 1825 EYE STREET NW, Washington, DC, 20006-5403, US

(21) Appl. No.: 12/166,077

(22) Filed: Jul. 1, 2008

(51) Int. Cl. G02B 5/18; B29D 11/00

(52) U.S. Cl. 359/571; 216/24

(57) ABSTRACT

Methods and apparatus reduce the chief ray angle incident on a pixel array of an imaging device by the use of a diffractive lens.

### FIELD OF THE INVENTION

Embodiments of the invention relate to correcting the angle of refraction of light.

### BACKGROUND

Solid state imaging devices, e.g., CCD, CMOS, and others, include a lens or series of lenses to direct incoming light onto a focal plane array of pixels. Each one of the pixels includes a photosensor, for example, a photogate, photoconductor, or photodiode, overlying a substrate for accumulating photo-generated charge in an underlying portion of the substrate. The charge generated by the pixels in the pixel array is then read out and processed to form an image.

FIG. 1 is a diagram of a portion of a focusing lens 110 and a pixel array 120 which is part of an imager die. The focusing lens 110 and imager die including pixel array are part of a self contained imager module. The focusing lens 110 is spaced at a distance x from the pixel array 120. It should be understood that the focusing lens 110 may be a simple or compound lens of varying shape and that only the back portion of such a lens 110 is shown in FIG. 1.

A transparent material 130 having an index of refraction nTM that is lower than the index of refraction nFL of the focusing lens 110 is arranged between the focusing lens 110 and the pixel array 120. Light rays 140a, 140b, 140c are refracted at the interface (shown by arrow A) between the focusing lens 110 and transparent material 130 to focus the light rays 140a, 140b, 140c onto the pixel array 120. The transparent material 130 may be a gas, e.g., air, or a solid material, e.g., glass or polymer.

Light rays 140a, 140b, 140c are generally focused by the focusing lens 110 into a conical bundle of light rays 140. The light ray in the center of the bundle of light rays 140 is known as the chief ray 140a and the angle of the chief ray is known as the chief ray angle. The chief ray angle is measured in relation to the normal of the planar surface 156 of the focusing lens 110, with an angle of zero degrees being perpendicular to the planar surface 156. As shown in FIG. 1, the material, shape, and distance x from the pixel array 120 of a focusing lens 110 are generally selected to optimally focus the bundle of light 140 having its chief ray angle 140a at zero degrees. The difference between the index of refraction nTM of the transparent material 130 and the index of refraction nFL of the focusing lens 110 is needed to focus light rays 140b, 140c peripheral to the chief ray 140a at a desired distance. For example, as shown in FIG. 1A, a light ray 940 having an angle of 8.2° in silicon 910 will be refracted to 350 in air 930 at a silicon/air interface (shown by Arrow D). As shown in FIG. 1B, a light ray 940 having an angle of 12.4° in silicon 910 will be refracted to 350 in glass 932 at a silicon/glass interface (shown by Arrow E).

However, as shown in FIG. 2, if light rays 140 passing through the focusing lens 110 at a chief ray angle that is sufficiently oblique or acute, light rays 140a, 140c exiting the focusing lens 110 at the interface between the focusing lens 110 and the transparent material 130 will be refracted outwards so that they may miss the pixel array 120 entirely or are not focused properly anymore, or enter the image sensor under a too large angle. In some instances, light rays may be partially or totally internally reflected as represented by 140d. The loss of light due to the refraction and/or reflection of light rays 140 having a high chief ray angle and/or their poor focusability, and/or their large angle in the image sensor will negatively affect the quality of an image generated by the pixel array 120.

What is needed is a system and method by which light rays having a high chief ray angle are redirected from a focusing lens onto a pixel array 120 of an imaging device.

### BRIEF DESCRIPTION OF THE DRAWINGS

FIG. 1 shows a lens, pixel array, and a bundle of light rays having a chief ray angle of zero degrees.

FIG. 1A shows a light ray passing from silicon into air.

FIG. 1B shows a light ray passing from silicon into glass.

FIG. 2 shows a lens, pixel array, and a bundle of light rays having an oblique chief ray angle.

FIG. 3A shows a side view of a blazed diffractive lens according to an embodiment described herein.

FIG. 3B shows a front view of a diffractive lens according to an embodiment described herein.

FIG. 3C shows a side view of a blazed diffractive lens according to an embodiment described herein.

FIG. 4A shows a lens, pixel array, diffractive lens according to an embodiment described herein, and light rays having an oblique chief ray angle.

FIG. 4B shows a pixel array, a lens integrated with a diffractive lens according to an embodiment described herein, and light rays having an oblique chief ray angle.

FIG. 5 shows a lens, pixel array, diffractive lens according to an embodiment described herein, and light rays having a chief ray angle of zero degrees.

FIG. 6A shows a side view of a diffractive lens according to an embodiment described herein.

FIG. 6B shows a front view of a diffractive lens according to an embodiment described herein.

FIG. 6C shows a side view of a diffractive lens according to an embodiment described herein.

FIG. 7 illustrates a block diagram of a CMOS imaging device constructed in accordance with an embodiment described herein.

FIG. 8 depicts a system constructed in accordance with an embodiment described herein.

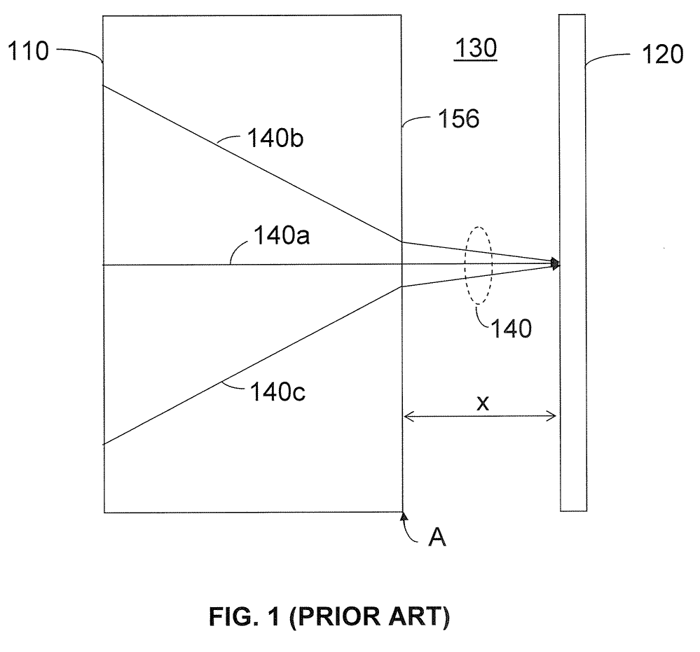

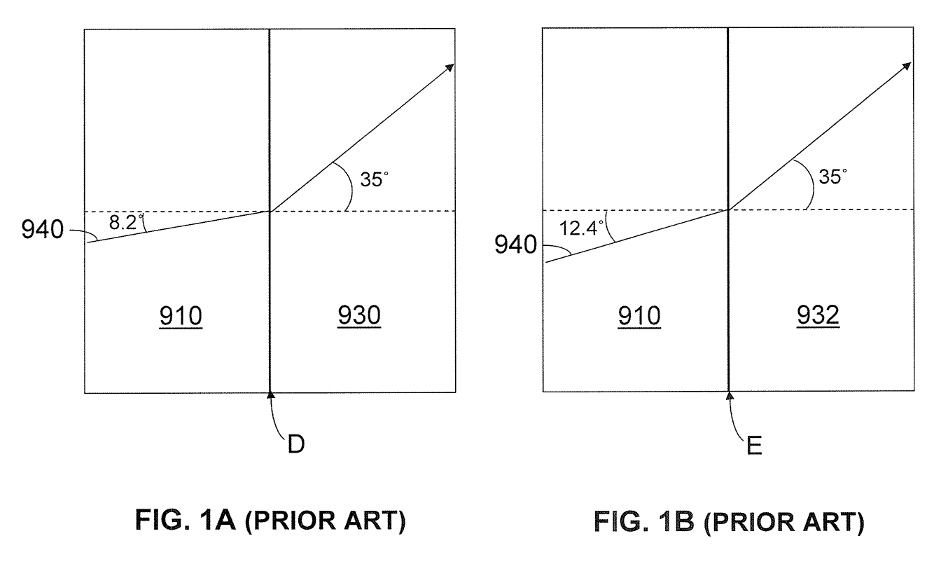

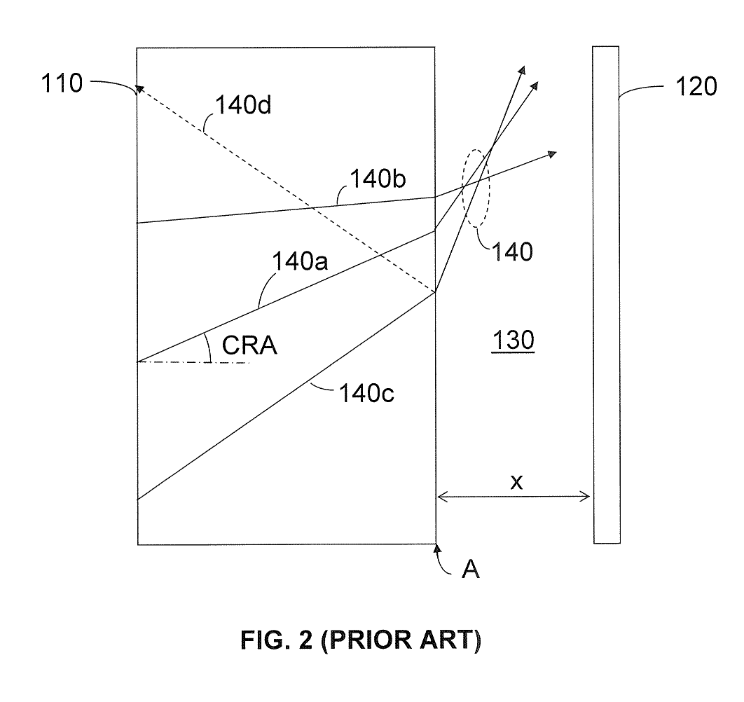

### DETAILED DESCRIPTION

In the following detailed description, reference is made to the accompanying drawings which form a part hereof, and in which are shown by way of illustration of specific embodiments that may be practiced. These embodiments are described in sufficient detail to enable those of ordinary skill in the art to make and use them, and it is to be understood that structural, logical or procedural changes may be made to the specific embodiments disclosed herein.

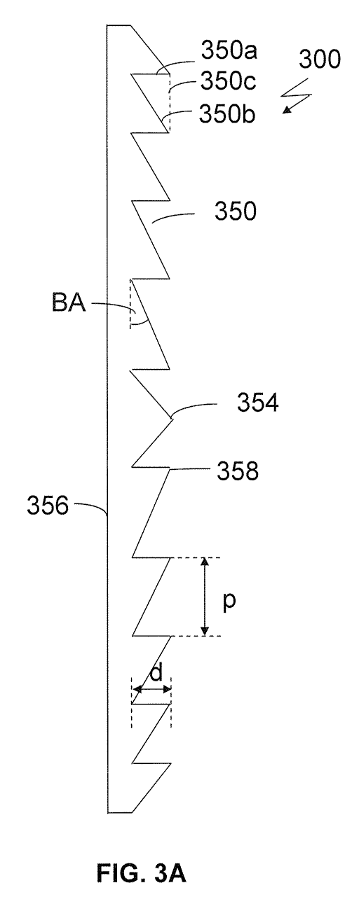

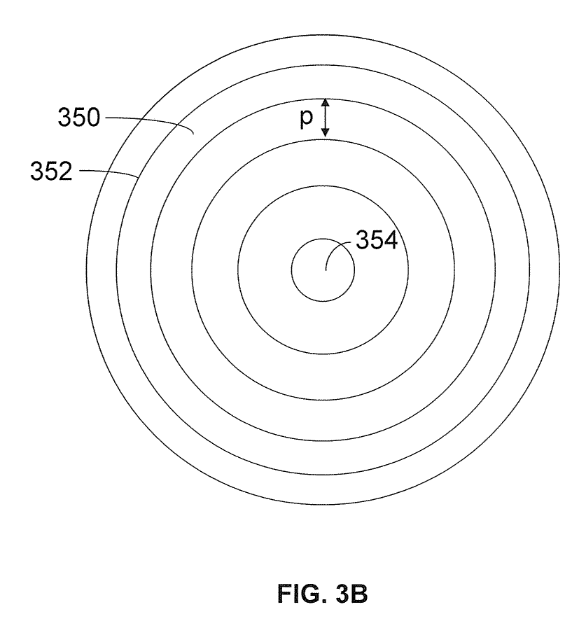

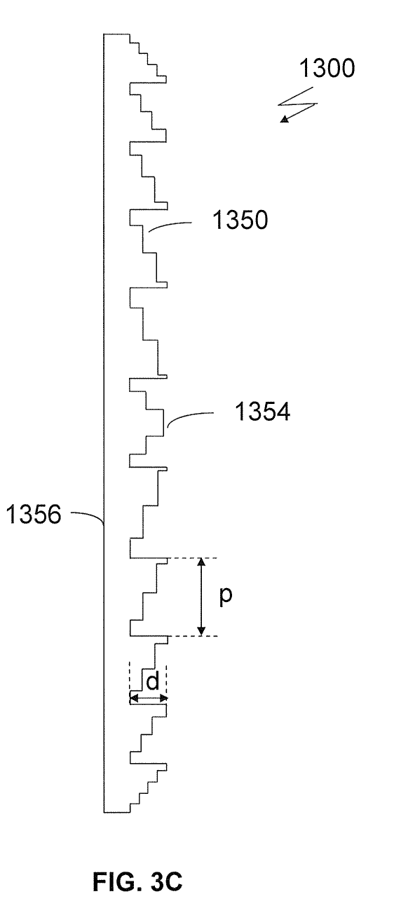

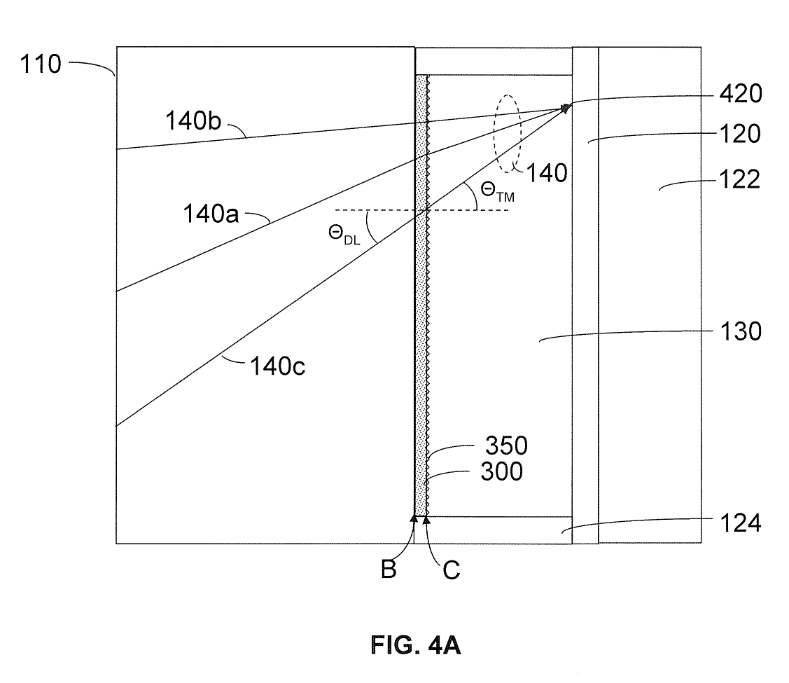

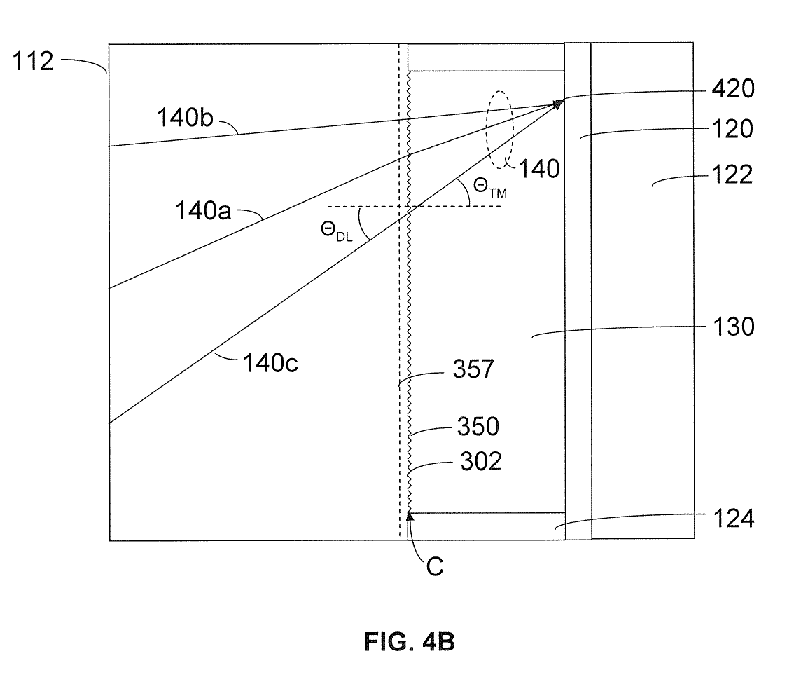

FIG. 3A shows a side view and FIG. 3B shows a front view of a diffractive lens 300 according to an embodiment described herein which may be used in conjunction with a focusing lens 110 to redirect light rays exiting focusing lens 110 toward pixel array 120. The diffractive lens 300 includes a planar surface 356 that faces focusing lens 110 and a surface 358 including a grating that faces a pixel array 120 and is made up of a series of grooves 350 arranged in concentric rings 352 around the center 354 of the diffractive lens 300. The rings 352 may be circles or irregularly shaped rings. The grooves 350 of the diffractive lens 300 are configured to diffract a bundle of light rays 140 having a chief ray angle that is not perpendicular to the planar surface 356 towards a predetermined location, for example, to a pixel array 120 (FIG. 4). Therefore, light rays having a chief ray angle that is oblique or acute are directed towards a pixel array 120 (FIG. 4).

To redirect the bundle of light rays 140, the period p, i.e., the width, of the grooves 350 located closer to the center 354 of the diffractive lens 300 is wider than the period p of the grooves 350 located farther away from the center 354 of the diffractive lens 300. In the embodiment shown in FIG. 3A, all of the grooves 350 have the same depth d. In alternative embodiments, the grooves 350 may have different depths. Although the diffractive lens 300 shown in FIG. 3A only includes 10 grooves 350, it should be understood that diffractive lenses according to embodiments described herein may have tens, hundreds, or thousands or more grooves concentrically arranged on the diffractive lens according to the size of the grooves and the size of the particular diffractive lens.

In the embodiment shown in FIG. 3A, the grooves 350 have a triangular shape. A triangular shape is formed by two sides 350a, 350b formed by the diffractive lens 300 itself, and a third open side 350c extending from peak to peak, where the peaks are located at the intersection of sides 350a and 350c and at the intersection of sides 350b and 350c. Furthermore, the grooves 350 in the embodiment shown in FIG. 3A have a triangular shape with a first side 350a arranged perpendicular to the planar surface 356 and a second side 350b that slopes in a downward direction (i.e. towards the planar surface 356) away from a center 354 of the diffractive lens 300. In alternate embodiments, both sides 350a, 350c may be sloped. Furthermore, the shape of the grooves 350 may vary in a manufactured structure and may be a four, eight, or sixteen level binary structure.

Therefore, because the period p of the grooves 350 changes according to the distance of a groove 350 from the center 354 of the diffractive lens 300, the angle of the second side 350b, known as the blaze angle BA, also changes according to the distance from the center 354 of the diffractive lens 300. The increase in the blaze angle BA and the decrease in the groove 350 period p at grooves further from the center 354 causes light rays striking the diffractive lens 300 at a location further from the center 354 to be diffracted to a greater degree than light rays striking the diffractive lens 300 at a location closer to the center 354.

FIG. 3C shows a diffractive lens 1300 formed as kinoform, i.e., a multi-level phase element. The grooves 1350 of the diffractive lens 1350 are formed of multi-levels of parallel surfaces to approximate the shape of the grooves 350 of the diffractive lens 300.

FIG. 4A is a diagram of an imager module having a diffractive lens 300 arranged between a focusing lens 110 and a pixel array 120 arranged on an image die 122. The focusing lens 110 and diffractive lens 300 are spaced apart from the pixel array 120 by spacers 124. A bundle of light 140 having a chief ray angle at an angle is shown passing through the focusing lens 110 and diffractive lens 300 to impinge on the pixel array 120. It should be understood that the focusing lens 110 may be a simple or compound lens of varying shape and that only the back portion of such a lens 110 is shown in FIG. 4.

Although the diffractive lens 300 and focusing lens 110 are shown in FIG. 4A as separate elements, it should be understood that the diffractive lens 300 and focusing lens 110 may be combined into one element with a diffractive grating 302 formed directly on the focusing lens 112, as shown in FIG. 4B. Where the diffractive lens 300 and the focusing lens 110 are combined into one focusing lens 112, the planar surface 357, i.e., the light entering side, of the diffractive lens that faces the focusing lens 112 and the light exiting side 357 of the focusing lens 112 are both defined as an arbitrary dividing line arranged parallel to the pixel array 120 between the grooves 350 and the rest of the focusing lens 112.

The transparent material 130 arranged between the focusing lens 110 and the pixel array 120 has an index of refraction nTM that is lower than the index of refraction nFL of the focusing lens 110 and the index of refraction nDL of the diffractive lens 300. In the embodiment shown in FIG. 4, the index of refraction nFL of the focusing lens 110 and the index of refraction nDL of the diffractive lens 300 are the same so that light is not refracted at the focusing lens 110/diffractive lens 300 interface (shown by arrow B). In the embodiment shown in FIG. 4A, the side 356 of diffractive lens 300 is in contact with the focusing lens 110.

The diffractive lens 300 and the focusing lens 110 may be made of the same materials, e.g., glass or polymer. Alternatively, the indexes of refraction nFL, nDL may be different and the diffractive lens 300 and focusing lens 110 may be made of different materials. The transparent material 130 may be a gas, e.g., air, or a solid material, e.g., glass or polymer.

As shown in FIG. 4A, a bundle of light rays 140 having a chief ray angle 140a at an angle not parallel to the planar surface 356 of the diffractive lens 300 are diffracted at the interface (shown by arrow C) between the diffractive lens 300 and the transparent material 130 such that the bundle of light rays 140 is redirected onto a predetermined location 420 on the pixel array 120. In one embodiment, the diffractive lens 300 may diffract the chief ray angle 140a so that it is the same in the transparent material 130 as it is in the diffractive lens 300. In another embodiment, the diffractive lens 300 may diffract the chief ray angle 140a so that it is smaller in the transparent material 130 than it is in the diffractive lens 300.

In one embodiment, a minimum of about four grooves 350 over the bundle may be used to diffract light rays 140 exiting the radially outer part of the diffractive lens 300 towards pixel array 120. There is no visible transition in the image produced by the pixel array 120 due to the grooves 350. The diffractive lens 300 can thus decrease or keep constant the chief ray angle of light exiting the diffractive lens 300.

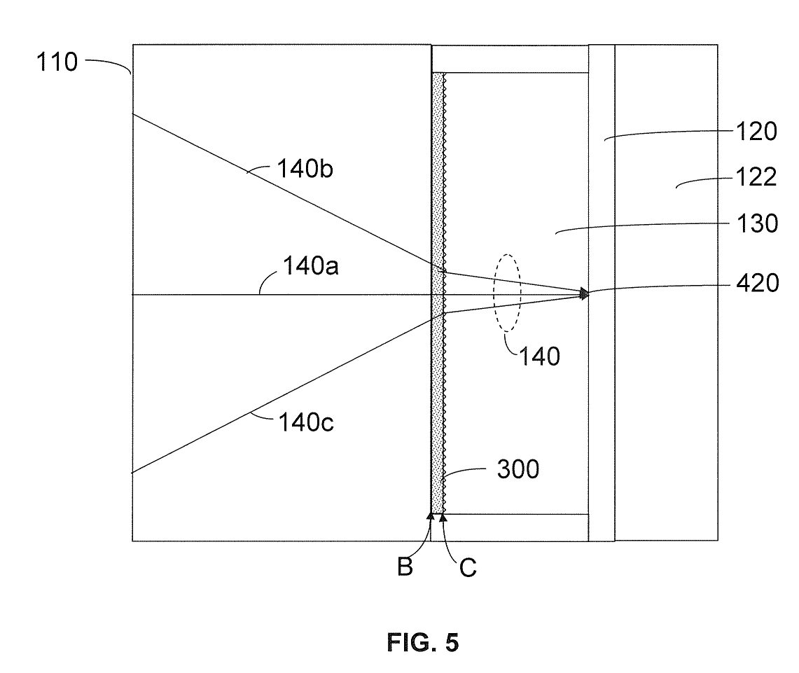

FIG. 5 is a diagram of the diffractive lens 300, focusing lens 110, pixel array 120, and a bundle of light 140 having a chief ray angle at zero degrees. Because the period p of the grooves is larger near the center 354 (FIG. 3A) of the diffractive lens 300, the light bundle 140 striking the lens with a chief ray angle of zero degrees near the center 354 of the diffractive lens 300 is not diffracted or is diffracted to a lesser degree than light striking the diffractive lens 300 near one of its edges.

The period p of the grooves 350 may vary depending on the amount of diffraction that is required for incoming light. In one embodiment, the period p of the grooves 350 may be between about 0.4 to about 4.0 μm, although the periods p will vary radially within a single lens 300 as described above. The depth d of the grooves 350 follows the required period and blaze angle for given diffraction/deflection angle.

In another embodiment, the period p used to refract a light ray at particular portion of the diffractive lens 300 may be determined by equation (1):

p=mλ/(nDL sin ΘDL−nTM sin ΘTM) (1)

where m is the diffraction order, λ is wavelength of the light ray, p is the period of the groove 350, nDL is the index of refraction of the diffractive lens 300, nTM is the index of refraction of the transparent material 130, ΘDL is the angle of the light ray in the diffractive lens 300 with respect to the normal of the planar surface 356 of the diffractive lens 300 (see FIG. 4), and ΘTM is the angle of the light ray in the transparent material 130 with respect to the normal of the planar surface 356 of the diffractive lens 300 (see FIG. 4).

For a specific case where it is desired that ΘTM equals ΘDL (with both represented as Θ) and m=1, equation (1) may be reduced to equation (2):

p=λ/(sin Θ(nDL−nTM)) (2)

Furthermore, if the diffractive lens 300 is made of glass and the transparent material 130 is made of air, and nDL−nTM is assumed to be 0.5, then equation (2) may be further reduced to equation (3):

p≈2λ/(sin Θ) (3)

where Θ is the angle of light both before and after passing through the diffractive lens 300/transparent material 130 interface. Θ can then be easily related to the desired angle of light striking the pixel array at any specific portion of the pixel array 120 and the period p and blaze angle BA of the grooves 350 can be adjusted accordingly and gradually at various radii of the diffractive lens 300.

For example, if the maximum desired angle of light striking the pixel array 120 is 35 degrees (Θmax=35 degrees), then for λ=0.55 um, the period p of the smallest groove 350, located at the edge of the diffractive lens 300, would be 1.9 μm. The diffractive dispersion of light in this example can be calculated for the visible spectrum from 0.42 μm to 0.65 μm wavelength to Θ_{0.42}=26 deg, Θ_{0.55}=35 deg, Θ_{0.65}=43 degrees. Thus, the dispersion of light having the maximum angle of 35 degrees is about ±8.5 deg for the visible spectrum.

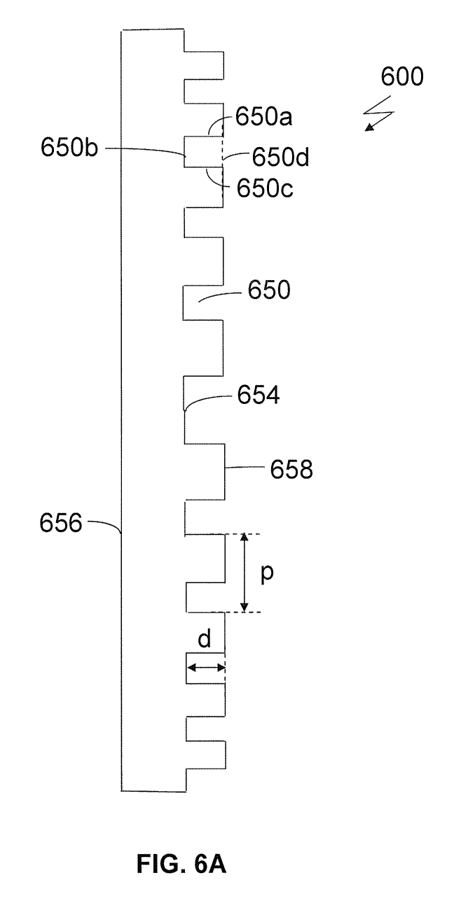

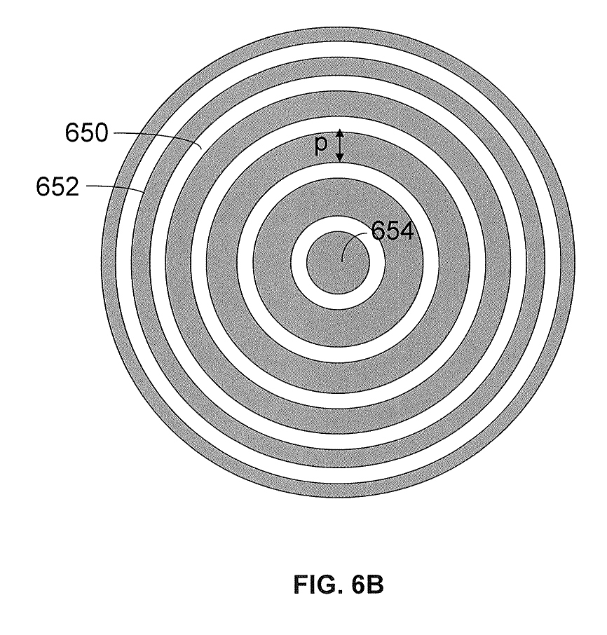

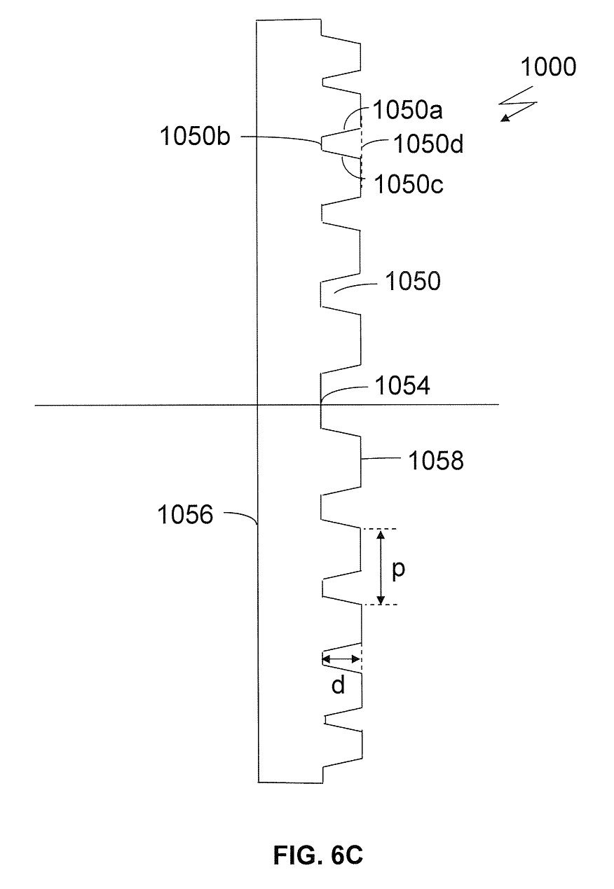

FIG. 6A shows a side view and FIG. 6B shows a front view of a diffractive lens 600 according to another embodiment described herein. The diffractive lens 600 includes a planar surface 656 and a grating made up of a series of grooves 650 arranged in concentric rings 652 around the center 654 of the diffractive lens 600. Similar to the diffractive lens 300 of FIGS. 3A and 3B, in order to redirect a bundle of light rays 140, the period p of grooves 650 located closer to the center 654 of the diffractive lens 600 is wider than the period p of grooves 650 located farther away from the center 654 of the diffractive lens 600.

In the embodiment shown in FIG. 6A, the grooves 650 have a rectangular shape. A rectangular shape is defined by three sides 650a, 650b, 650c formed by the diffractive lens 600 itself, and a fourth side 650d being open. In the embodiment shown in FIG. 6A, the rectangular grooves 650 include a first side 650a and a second side 650c arranged substantially perpendicular to the diffractive lens and a third side 650b arranged substantially parallel to the planar surface 656 of the diffractive lens 600. The fill factor, i.e., the width of the grooves vs. the distance between the grooves, determines the diffraction efficiency in a particular diffraction order. The fill factor moves the diffraction envelope over grating orders to maximize diffraction efficiency for a given deflection angle or diffraction order, respectively. The width of the grooves 350 in FIG. 3A accomplishes the same purpose, but even more efficiently.

The decrease in the groove 650 period p at grooves further from the center 654 causes light rays striking the diffractive lens 600 at a location further from the center 654 to be more diffracted at a greater angle than light rays striking the diffractive lens 600 at a location closer to the center 654.

The depth d of the grooves 650 may be configured so that the optical path difference between rays passing through the grooves and passing through the bumps in perpendicular transmission is an integer multiple of the center wavelength of the imaging device to cause constructive interference. Constructive interference may be achieved where i is an integer value and where d=Iλ/(nDL−nTM).

FIG. 6C shows a side view of a diffractive lens 1000 according to another embodiment described herein. The diffractive lens 1000 includes a planar surface 1056 and a grating made up of a series of grooves 1050 arranged in concentric rings 1052 around the center 1054 of the diffractive lens 1000. Similar to diffractive lenses 300, 600, in order to redirect a bundle of light rays 140, the period p of grooves 1050 located closer to the center 1054 of the diffractive lens 1000 is wider than the period p of grooves 1050 located farther away from the center 1054 of the diffractive lens 1000.

In the embodiment shown in FIG. 6C, the grooves 1050 have a trapezoidal shape. A trapezoidal shape is defined by three sides 1050a, 1050b, 1050c formed by the diffractive lens 1000 itself, and a fourth side 1050d being open. In the embodiment shown in FIG. 10, the trapezoidal grooves 1050 include a first side 1050a and a second side 1050c arranged at an angle to planar side 1056 of the diffractive lens 1000 and a third side 1050b arranged substantially parallel to the planar surface 1056 of the diffractive lens 1000.

The grooves 350, 650, 1050 described herein may be formed by precision single point diamond turning, although the limited diamond radius may not allow for certain features, such as edge sharpness of the grooves 350, 650, 1050, or certain sizes to be achieved. In other embodiments, the grooves 350, 650, 1050 may be formed by laser or electron beam writing, gray scale lithography, or multilevel kinoforms using multiple binary marks and subsequent replication and/or etching steps using a photoresist and ultraviolet cured polymer and glass, respectively.

The diffractive lens 300 may be included in wafer level optical modules formed by aligning and assembling a wafer containing multiple lens structures to a wafer containing multiple imager dies. The wafer containing multiple lens structures may be spaced apart from the wafer containing multiple imager dies by a spacer wafer. The assembled wafers may then be cut to form individual imager modules. The diffractive lenses may be included as a separate wafer or may be a part of the wafer containing the multiple lens structures.

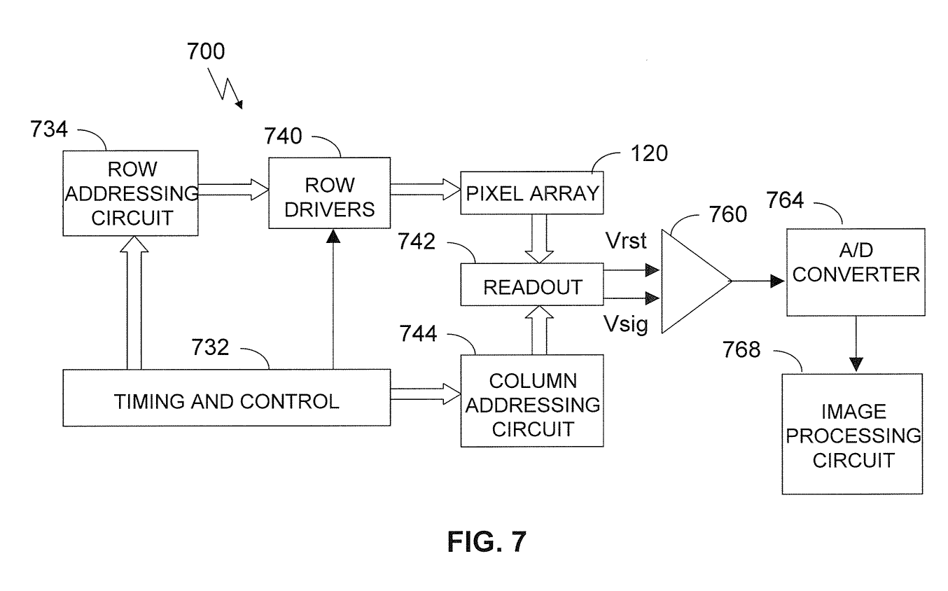

FIG. 7 shows a block diagram of an imaging device 700, e.g. a CMOS imager, that may be used in conjunction with a diffractive lens 300, 600, 1000 according to embodiments described herein. A timing and control circuit 732 provides timing and control signals for enabling the reading out of signals from pixels of the pixel array 120 in a manner commonly known to those skilled in the art. The pixel array 120 has dimensions of M rows by N columns of pixels, with the size of the pixel array 120 depending on a particular application.

Signals from the imaging device 700 are typically read out a row at a time using a column parallel readout architecture. The timing and control circuit 732 selects a particular row of pixels in the pixel array 120 by controlling the operation of a row addressing circuit 734 and row drivers 740. Signals stored in the selected row of pixels are provided to a readout circuit 742. The signals are read from each of the columns of the array sequentially or in parallel using a column addressing circuit 744. The pixel signals, which include a pixel reset signal Vrst and image pixel signal Vsig, are provided as outputs of the readout circuit 742, and are typically subtracted in a differential amplifier 760 and the result digitized by an analog to digital converter 764 to provide a digital pixel signal. The digital pixel signals represent an image captured by pixel array 120 and are processed in an image processing circuit 768 to provide an output image.

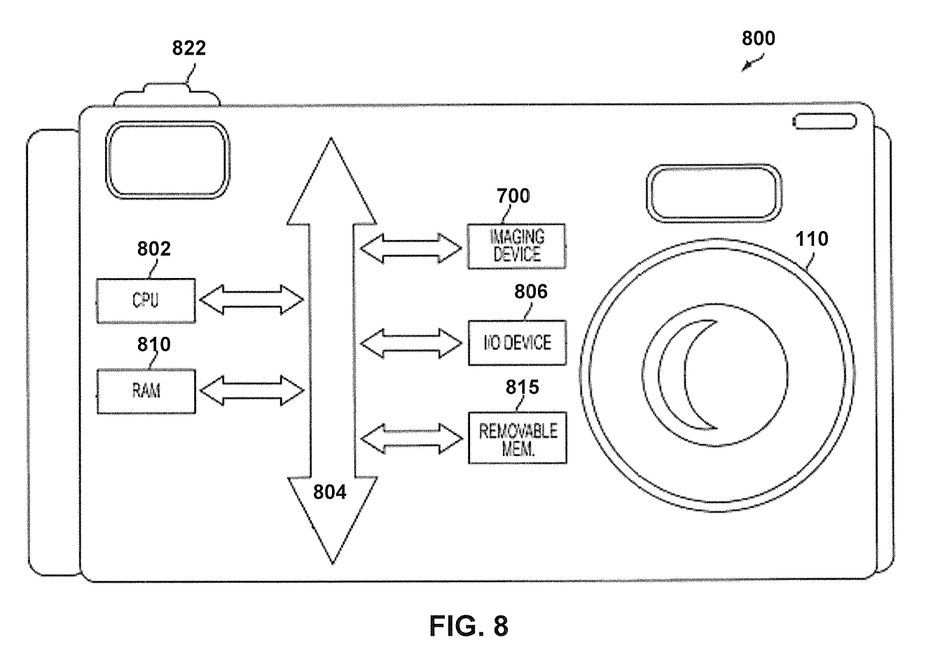

FIG. 8 shows a system 800 that includes an imaging device 700 and a focusing lens 110 used in conjunction with a diffractive lens 300, 600 constructed and operated in accordance with the various embodiments described above. The system 800 is a system having digital circuits that include imaging device 700. Without being limiting, such a system could include a computer system, camera system, e.g., a camera system incorporated into an electronic device, such as a cell phone, scanner, machine vision, vehicle navigation, video phone, surveillance system, auto focus system, star tracker system, motion detection system, image stabilization system, or other image acquisition system.

System 800, e.g., a digital still or video camera system, generally comprises a central processing unit (CPU) 802, such as a control circuit or microprocessor for conducting camera functions, that communicates with one or more input/output (I/O) devices 806 over a bus 804. Imaging device 700 also communicates with the CPU 802 over the bus 804. The processor system 800 also includes random access memory (RAM) 810, and can include removable memory 815, such as flash memory, which also communicates with the CPU 802 over the bus 804. The imaging device 700 may be combined with the CPU processor with or without memory storage on a single integrated circuit or on a different chip than the CPU processor. In a camera system, a focusing lens 110 in conjunction with a diffractive lens according to various embodiments described herein may be used to focus image light onto the pixel array 120 of the imaging device 700 and an image is captured when a shutter release button 822 is pressed.

While embodiments have been described in detail in connection with the embodiments known at the time, it should be readily understood that the claimed invention is not limited to the disclosed embodiments. Rather, the embodiments can be modified to incorporate any number of variations, alterations, substitutions or equivalent arrangements not heretofore described. For example, while some embodiments are described in connection with a CMOS pixel imaging device, they can be practiced with any other type of imaging device (e.g., CCD, etc.) employing a pixel array or a camera using film instead of a pixel array.

1. An imaging structure, comprising:
a focusing lens structure for focusing an image, the focusing lens having a light exiting side;
a pixel array for capturing the image focused by the focusing lens structure;
a diffractive lens arranged between the focusing lens structure and the pixel array; and
a transparent material arranged between the diffractive lens and the pixel array,
wherein the diffractive lens comprises:
a light entering first side facing towards the light exiting side of the focusing lens structure, and
a second side facing towards the pixel array, the second side comprising a grating, the grating comprising a plurality of grooves arranged in concentric rings,
wherein a period of the grooves decreases according to an increase in distance from a center of the grating.

2. The imaging device of claim 1, wherein the first side is planar.

3. The imaging device of claim 2, wherein a minimum period of each of the plurality of grooves is between about 0.4 to about 4.0 micrometers.

4. The imaging device of claim 2, wherein a period of at least one of the plurality of grooves is determined by the equation:
p=mλ/(nDL sin ΘDL−nTM sin ΘTM)
where m is a diffraction order, λ is wavelength of a light ray entering the diffractive lens, p is a period of the groove, nDL is an index of refraction of the diffractive lens, nTM is an index of refraction of the transparent material, ΘDL is an angle of the light ray in the diffractive lens with respect to the first side of the diffractive lens, and ΘTM is an angle of the light ray in the transparent material with respect to the second side of the diffractive lens.

5. The imaging device of claim 4, wherein ΘTM=ΘDL and m=1.

6. The imaging device of claim 5, wherein the diffractive lens comprises glass or polymer and the transparent material comprises air, and wherein nDL−nTM is approximately equal to 0.5.

7. The imaging device of claim 1, wherein all of the grooves have the same depth.

8. The imaging device of claim 1, wherein the grooves are substantially triangular in shape.

9. The imaging device of claim 8, wherein blaze angles of substantially triangular grooves located farther from a center of the grating are larger than blaze angles of substantially triangular grooves located closer to the center of the grating, wherein the blaze angles are measured with regard to the first side.

10. The imaging device of claim 8, wherein the substantially triangular grooves comprise a first side arranged substantially perpendicular to the first surface and a second side that slopes in a downward direction away from a center of the grating.

11. The imaging device of claim 1, wherein the grooves are substantially rectangular in shape.

12. The imaging device of claim 11, wherein the substantially rectangular grooves comprise a first side and a second side arranged substantially perpendicular to the first surface and a third side arranged substantially parallel to the first surface.

13. The imaging device of claim 1, wherein the grooves are substantially trapezoidal in shape.

14. The imaging device of claim 13, wherein the substantially trapezoidal grooves comprise a first side arranged substantially parallel to the first surface and a second side and a third side sloping downwards and inwards towards the first side.

15. The imaging device of claim 1, wherein the focusing lens and the diffraction lens are in direct contact with each other.

16. The imaging device of claim 1, wherein the diffraction lens is integral to the focusing lens.

17. The imaging device of claim 1, wherein an index of refraction of the diffractive lens is approximately equal to an index of refraction of the focusing lens and wherein an index of refraction of the transparent material is less than the index of refraction of the diffractive lens.

18. A camera system employing the imaging device of claim 1.

19. An imaging module, comprising:
an imager die comprising a pixel array;
a focusing lens structure for focusing an image onto the pixel array;
a transparent material arranged between the focusing lens and the pixel array; and
a diffractive grating comprising a plurality of grooves arranged between said focusing lens structure and said transparent material,
said focusing lens structure, diffractive grating, and transparent material being joined as a modular structure.

20. The imaging module of claim 19, wherein grooves located closer to a center of the grating are wider than grooves located farther from the center of the grating and wherein all of the grooves have the same depth.

21. The imaging module of claim 19, wherein the grooves comprise a first side arranged substantially perpendicular to the pixel array and a second side that slopes in a downward direction away from a center of the surface.

22. The imaging module of claim 19, wherein the grooves comprise a first side and a second side arranged substantially perpendicular to the pixel array and a third side arranged substantially parallel to the pixel array.

23. The imaging module of claim 19, wherein a period of at least one of the plurality of grooves is determined by the equation:
p=mλ/(nDL sin ΘDL−nTM sin ΘTM)
where m is a diffraction order, λ is wavelength of a light ray within the focusing lens, p is a period of the groove, nDL is an index of refraction of the focusing lens, nTM is an index of refraction of the transparent material, ΘDL is an angle of the light ray in the focusing lens with respect to the pixel array, and ΘTM is an angle of the light ray in the transparent material with respect to the pixel array.

24. A method of forming an imager module, comprising:
providing a first wafer containing a plurality of imager dies;
providing a second wafer containing a plurality of lens structures for focusing an image onto the plurality of imager dies;
providing a transparent material;
providing a diffractive grating comprising a plurality of grooves;
coupling the first wafer to the second wafer to form a structure in which the diffractive grating is arranged between the first wafer and the second wafer and the transparent material is arranged between the diffractive grating and the first wafer; and
dividing the structure into a plurality of imager modules, each module comprising an imager die, a lens structure, a diffractive grating, and a transparent material.

25. The method of claim 24, further comprising forming the plurality of grooves by laser or electron beam writing.

26. The method of claim 24, further comprising forming the plurality of grooves by gray scale lithography and subsequent replication and/or etching steps.

27. The method of claim 24, further comprising forming the plurality of grooves by diamond turning and a subsequent lithography technique.

28. The method of claim 24, further comprising forming multilevel kinoform elements by multiple binary marks.

29. The method of claim 24, wherein grooves located closer to a center of the grating are wider than grooves located farther from the center of the grating.

30. The method of claim 24, wherein the grooves are substantially triangular in shape and wherein blaze angles of substantially triangular grooves located farther from a center of the grating are larger than blaze angles of substantially triangular grooves located closer to the center of the grating.

31. The method of claim 24, wherein the grooves are substantially rectangular or substantially trapezoidal in shape.
